(19) United States
(12) Patent Application Publication
(10) Pub. No.: US 2011/0229294 A1
(43) Pub. Date: Sep. 22, 2011

(54) Apparatus and Method for Lifting And/Or Lowering Stretchers Or Gurneys Into, Or Out Of, Emergency Vehicles

(76) Inventor: Mark Gale, Jupiter, FL (US)

(21) Appl. No.: 13/050,448

(22) Filed: Mar. 17, 2011

Related U.S. Application Data
(60) Provisional application No. 61/314,698, filed on Mar. 17, 2010.

(51) Int. Cl. B60P 1/44

(52) U.S. Cl. 414/558

(57) ABSTRACT

An integral lift assembly incorporated into a storage compartment under the patient compartment of an emergency vehicle. The integral lift assembly is stored in the storage compartment until a patient is loaded onto the emergency vehicle. During the loading process, the integral lift assembly extends, under power, from the storage compartment, and is lowered to the ground to allow a stretcher or gurney to be rolled onto it. A lift arm raises the structure or gurney, under power, and automatically aligns it with the floor of the patient compartment. The stretcher or gurney is then rolled into the patient compartment. The lift arm then rotates to a storage position and is retracted to a storage compartment underneath the patient compartment.

### CROSS-REFERENCE TO RELATED APPLICATIONS

This application is related to, and claims the benefit of, the provisional patent application entitled “Apparatus and Method for Lifting And/Or Lowering Stretchers Or Gurneys Into, Or Out Of, Emergency Vehicles”, filed Mar. 17, 2010, bearing U.S. Ser. No. 61/314,698 and naming Mark Gale, the named inventor herein, as sole inventor, the contents of which is specifically incorporated by reference herein in its entirety.

### BACKGROUND

1. Technical Field

This invention relates in general to emergency vehicles, and more particularly it relates to an emergency vehicle that has an integral powered lift mechanism to raise or lower a cot, stretcher or gurney when loading the cot, stretcher or gurney onto, or off of, the emergency vehicle.

2. Background of the Invention

First responders to emergency situations are often required to transport an individual, whether injured or unconscious, to a treatment facility such as a hospital. A variety of individuals work as first responders. They can be ambulance personnel, fire department personnel, etc. Regardless of their status, they are exposed to potential injury on daily basis. The reason for this is that when transporting patients, the patients often have to be carried and lifted onto an ambulance or other of emergency vehicle. Normally, personnel who work in this field are physically fit and lifting a cot, stretcher or gurney when transporting an ordinary individual is not a problem. However, there are situations, such as transporting bariatric patients, where the patient's weight in combination with the weight of the gurney can be substantial. When this happens, emergency personnel are exposed to a risk of injury to themselves or the patient.

A major risk to emergency workers, among other things, is the possibility of back injuries. This type of injury often results in debilitating pain that prevents an individual from working. Further, this type of injury often requires surgery, and in many cases results in lifelong problems. It would be desirable to have a way for emergency workers to avoid this type of injury.

Back injuries affect more than the individual worker. They also create substantial financial costs for the employer. This type of injury can have a very large effect on the employer's medical costs, and may result in lifelong disability payments. As a result, employers also have a substantial interest in avoiding this type of injury to their personnel.

In addition to emergency personnel and their employer, back injuries may also place the patient at risk. For example, when emergency medical personnel attempt to lift a patient, a back injury to emergency medical personnel may cause the patient to be dropped. This has a potential for injury to the patient that may result in further medical costs and litigation that could be very expensive for the employer.

Attempts to address this problem have resulted in the development of gurneys with built-in lifts. The lifts may be raised or lowered under power, or manually operated. While this helps, at some point the emergency medical personnel are still required to lift the patient to move the patient onto the ambulance or other emergency vehicle. As a result, there is still a possibility of injury. It would be desirable to have a method of loading a patient on to, or off of, an emergency vehicle without requiring the emergency personnel to physically lift the patient.

The prior art has provided a variety of cots, stretchers and gurneys that are wheeled, and which may optionally have power lifts to raise the patient. For ease of discussion, the terms “ambulance cot,” “stretcher,” and “gurney” will be used interchangeably throughout this specification. Unfortunately, this type of gurney is typically not designed to exactly match the floor level of a given emergency vehicle. As a result, the mismatch between the floor level of emergency vehicle and the height of the gurney still requires some lifting on the part of emergency medical personnel. The prior art has failed to provide a method of loading the patient onto an emergency vehicle that only requires a wheeled gurney to be rolled onto the emergency vehicle.

### SUMMARY OF THE INVENTION

This invention provides an integral lift assembly that is incorporated into an emergency vehicle. The integral lift assembly is stored underneath the floor of the patient compartment of the emergency vehicle. When the patient is loaded onto the emergency vehicle, the integral lift assembly is extended, under power, from underneath the patient compartment. A lift arm in the integral lift assembly is rotated and lowered to the ground to allow the stretcher or gurney to be mounted on it. The lift arm is then raised, under power, and automatically aligned with the floor of the patient compartment. The gurney is then rolled into the patient compartment. The lift arm then rotates to a storage position and is retracted to a storage compartment underneath the patient compartment.

### BRIEF DESCRIPTION OF THE DRAWINGS

FIG. 1 is a side transparent view of a preferred embodiment of an emergency vehicle with the integral lift assembly in the storage position.

FIG. 2 is a side transparent view of a preferred embodiment of an emergency vehicle with the integral lift assembly in the extended position.

FIG. 3 is a side transparent view of a preferred embodiment of an emergency vehicle with the lift arm of the integral lift assembly in the lowered position.

FIG. 4 is a side transparent view of a preferred embodiment of an emergency vehicle with the lift arm of the integral lift assembly in the raised position.

FIG. 5 is a side transparent view of a preferred embodiment of an emergency vehicle with the lift arm of the integral lift assembly in the retracted raised position prior to loading a gurney onto the emergency vehicle.

FIG. 6 is a side transparent view of a preferred embodiment of an emergency vehicle with the lift arm of the integral lift assembly in the retracted raised position after loading a gurney onto the emergency vehicle.

FIG. 7 is a side transparent view of a preferred embodiment of an emergency vehicle with the integral lift assembly in the extended storage position prior to storage of the integral lift into the emergency vehicle.

FIG. 8 is a side transparent view of a preferred embodiment of an emergency vehicle with the integral lift assembly in the retracted storage position after storage of the integral lift into the emergency vehicle.

FIG. 9 is an end view of a preferred embodiment of an emergency vehicle with the integral lift assembly in the retracted storage position.

### DETAILED DESCRIPTION OF THE PREFERRED EMBODIMENT

The invention provides a retractable folding lift assembly that is stored in a storage compartment under the patient compartment of an emergency vehicle. When a patient is loaded onto the emergency vehicle, the retractable folding left assembly extends outward from the storage compartment and then lowers a lift arm to the ground to allow a stretcher or gurney to be loaded onto it. Likewise, it is assumed that a patient is on the gurney, but for ease of illustration, patients have been omitted from the drawings. Once the gurney is loaded onto the lift assembly, the lift arm raises the gurney and automatically aligns it with the floor of the patient compartment to allow a gurney to be rolled into the patient compartment without lifting the gurney. As a result, serious back injuries to emergency personnel are avoided because they are not required to lift the gurney or the patient to get the patient into the emergency vehicle. Once the patient and the gurney are loaded into the patient compartment, the lift arm folds onto the lift mechanism and is retracted into the storage compartment underneath the patient compartment.

The invention provides advantages for the emergency personnel, for their employer, and for the patients. The ability to load a patient onto an ambulance, especially a bariatric patient, without requiring emergency personnel to lift the patient will avoid injuries to the emergency personnel. In particular, not being required to lift heavy weights will avoid numerous back injuries which can be expensive to treat, and which can cause debilitating pain to the employee. The employer benefits because reduction in injuries to employees has a direct effect on the profitability of the organization. Patients also benefit because they can be safely loaded onto an emergency vehicle with the greatly reduced possibility of accidental injury. This also affects the employer's profitability because the employer is less likely to be exposed to litigation from any injury to a patient.

For ease of discussion, the drive mechanism that powers the integral lift assembly is described in terms of a pneumatic system. However, those skilled in the art will recognize that alternative power systems can be used, such as electric motors, internal combustion engine drives, etc.

For ease of discussion, the integral lift system is shown as an integral part of the emergency vehicle that may have been installed at the point of manufacture of the vehicle. However, those skilled in the art will recognize that the integral lift system can also be manufactured separately and installed as a retrofit system on pre-existing emergency vehicles.

Having discussed the features and advantages of the invention in general, we turn now to a discussion of the drawings.

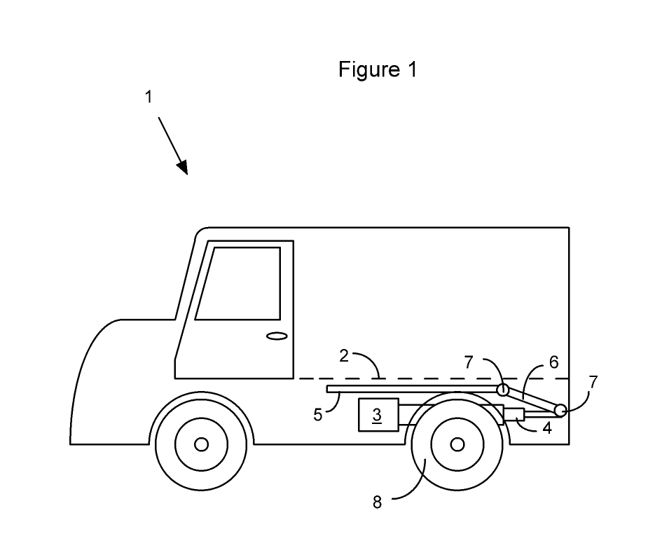

FIG. 1 is a side transparent view of a preferred embodiment of an emergency vehicle 1 with the integral lift assembly 3-7 in the storage position. In this position, the storage position, the integral lift assembly 3-7 is stored underneath the floor 2 of the patient compartment of the emergency vehicle 1. As shown in this figure, the integral lift assembly 3-7 folds into a compact storage configuration that takes a minimum amount of space. The integral lift assembly 3-7 comprises a telescoping support 4, a hydraulic power system 3 attached to the telescoping support 4, a lift arm 5, and a rotating arm 6 which is attached to the list arm 5 and the telescoping support 4 via hydraulic drives 7. Also shown in this figure are wheels 8. As can be seen, the integral lift assembly 3-7 can be secured between the real wheels and under the floor 2 of the passenger compartment of the emergency vehicle 1. Telescoping supports, hydraulic drives, and pivoting arms are well known in the art and do not require more detailed descriptions herein.

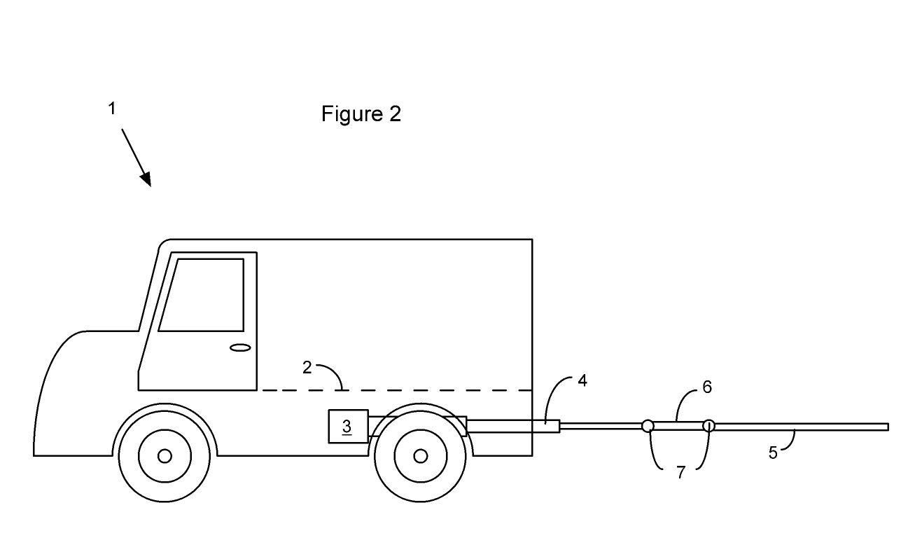

FIG. 2 is a side transparent view of a preferred embodiment of an emergency vehicle 1 with the integral lift assembly 3-7 in the extended position. In this position, the telescoping support 4 extends outward a sufficient distance to allow the lift arm 5 to rotate under control of the rotating arm 6 and the hydraulic drives 7.

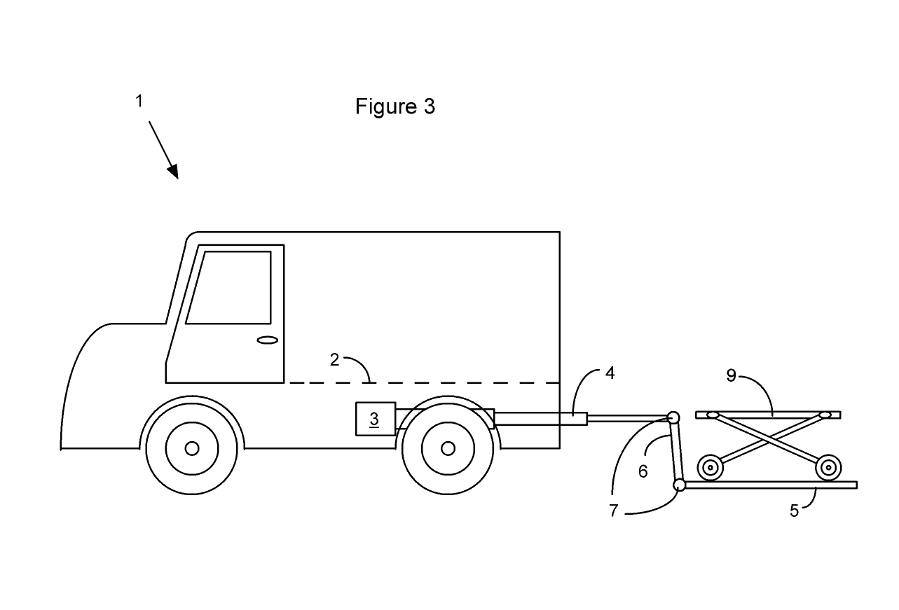

FIG. 3 is a side transparent view of a preferred embodiment of the emergency vehicle 1 with the lift arm 5 of the integral lift assembly 3-7 in the lowered position. In this position, the lift arm 5 rests on the ground. This allows the gurney 9 to be rolled onto the lift arm 5 merely by pushing it into position. The gurney 9 does not have to be lifted.

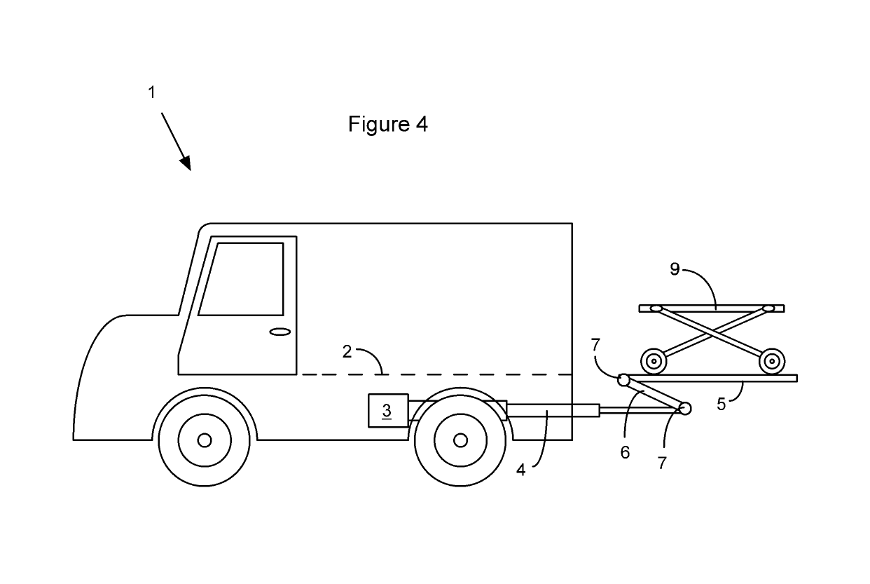

FIG. 4 is a side transparent view of a preferred embodiment of an emergency vehicle 1 with the lift arm 5 of the integral lift assembly 3-7 in the raised position. In this position, the gurney 9 has been raised such that the top surface of the lift arm 5 is substantially aligned with the top surface of the floor 2 of the passenger compartment of the emergency vehicle 1.

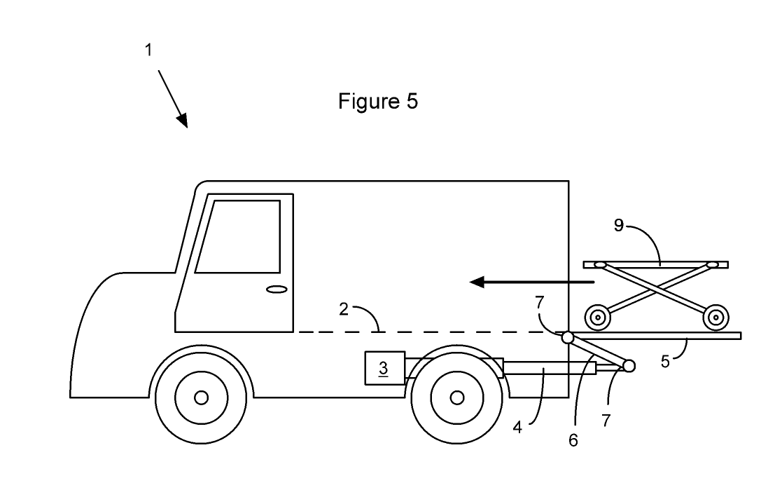

FIG. 5 is a side transparent view of a preferred embodiment of an emergency vehicle 1 with the lift arm 5 of the integral lift assembly 3-7 in the retracted raised position prior to loading a gurney onto the emergency vehicle 1. In this position, the telescoping support 4 is retracted such that the edge of the lift arm 5 is substantially in contact with the edge of the floor 2 of the patient compartment. At this point, the gurney 9 can be pushed, in the direction indicated by the arrow, into the passenger compartment. By automatically aligning the lift arm 5 with the floor 2 of the passenger compartment, the emergency personnel only need to push the gurney 9, they do not have to lift it.

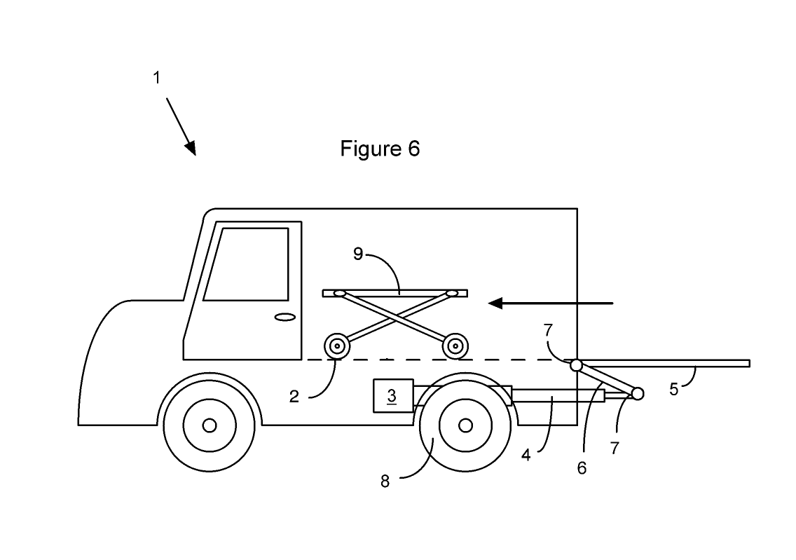

FIG. 6 is a side transparent view of a preferred embodiment of an emergency vehicle 1 with the lift arm 5 of the integral lift assembly 3-7 in the retracted raised position after loading a gurney 9, as indicated by the arrow, onto the emergency vehicle 1.

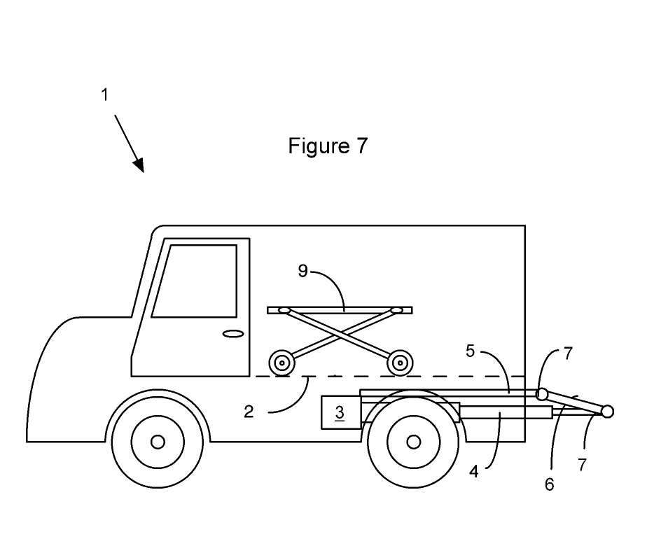

FIG. 7 is a side transparent view of a preferred embodiment of an emergency vehicle 1 with the integral lift assembly 3-7 in the extended storage position prior to storage into the emergency vehicle 1.

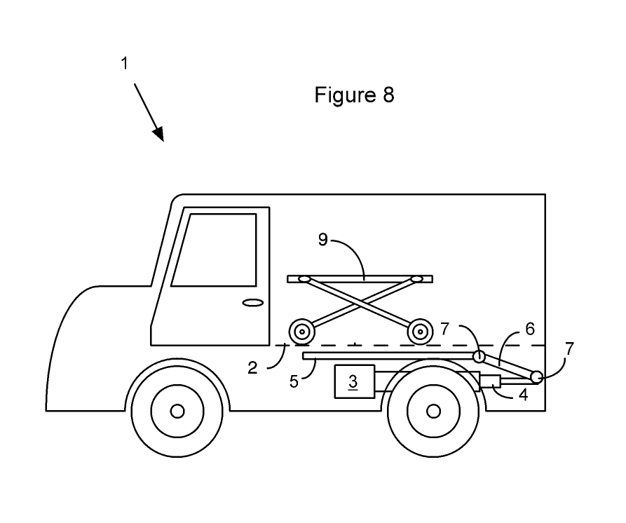

FIG. 8 is a side transparent view of a preferred embodiment of an emergency vehicle 1 with the integral lift assembly 3-7 in the retracted storage position in the emergency vehicle 1.

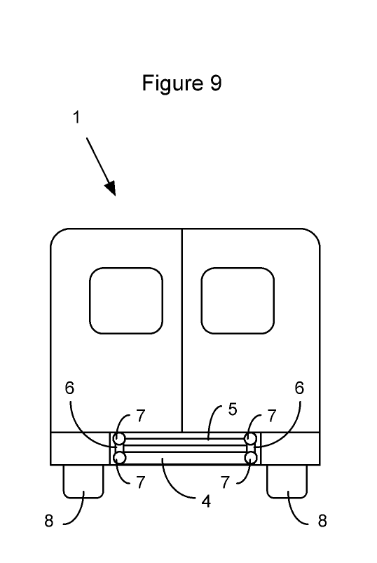

FIG. 9 is an end view of a preferred embodiment of an emergency vehicle 1 with the integral lift assembly 3-7 in the retracted storage position.

Those skilled in the art will recognize that the integral lift assembly 3-7 can be fabricated from any suitable material. The only requirement is that whatever materials are selected should be suitable for the contemplated weights to be lifted, and for environmental factors. Likewise, the use of a pneumatic drive system 3 was only one potential method of controlling the motion of the lift arm 5. Any suitable alternative method, such as electric motors, rack and pinion systems, etc. can be used in place of the pneumatic drive system 3, or in combination with it. Of course, the size of the various components of the integral lift assembly 3-7 can vary to suit particular vehicles and purposes.

In operation, the invention provides a conveniently located, power driven system, which eliminates the need for emergency personnel to lift the heavy weights that are a primary cause of back injuries among emergency personnel.

While specific embodiments have been discussed to illustrate the invention, it will be understood by those skilled in the art that variations in the embodiments can be made without departing from the spirit of the invention. Materials may be substituted, drive systems can be changed, sizes can be changed to suit particular vehicles, etc. Therefore, the invention shall be limited solely by the scope of the claims.

I claim:

1. An integral lift assembly for an emergency vehicle, comprising:
a storage compartment having a suitable size to contain a lift arm, a telescoping support, and a power drive system to manipulate the lift arm and the telescoping support;
means to extend the lift arm with the telescoping support and to rotate the lift arm such that it rests in a lowered position;
means to rotate the lift arm such that it is substantially aligned with the floor of the passenger compartment in the emergency vehicle;
means to retract the integral lift assembly into the storage compartment.
